(19) United States
(12) Patent Application Publication
(10) Pub. No.: US 2024/0375632 A1
(43) Pub. Date: Nov. 14, 2024

(54) METHOD FOR ACTUATING A BLOCKING TAPPET, ACTUATION UNIT AND VEHICLE BRAKE

(71) Applicant: Continental Automotive Technologies GmbH, Hannover (DE)

(72) Inventors: Peter Stauder, Mainz (DE); Tom Kaufmann, Ippenschied (DE); Achim Netz, Rodgau (DE)

(73) Assignee: Continental Automotive Technologies GmbH, Hannover (DE)

(21) Appl. No.: 18/686,666

(22) PCT Filed: Aug. 19, 2022
(86) PCT No.: PCT/DE2022/200193

§ 371 Date: Feb. 26, 2024

(30) Foreign Application Priority Data
Aug. 26, 2021 (DE) 10 2021 209 379.5

(51) Int. Cl. B60T 13/74; B60T 8/171; B60T 8/172; B60T 17/22; F16D 63/00; F16D 65/16; F16D 66/00; F16D 121/20; F16D 127/06

(52) U.S. Cl. CPC B60T 13/746; B60T 8/171; B60T 8/172; B60T 17/221; F16D 63/006; F16D 65/16; F16D 66/00; F16D 2066/003; F16D 2121/20; F16D 2127/06

(57) ABSTRACT

The invention relates to a method for actuating a blocking slide which is actuatable by means of an electromagnet and which, in at least one position, engages into a structured surface, whereby the blocking slide prevents a rotation of the structured surface in at least one direction of rotation, wherein, before a deployment of the blocking slide, the structured surface is moved into a specified orientation. The invention furthermore relates to an actuating unit for carrying out such a method, and to a vehicle brake having such an actuating unit.

The invention relates to a method for actuating a blocking slide which is actuatable by means of an electromagnet and which, in at least one position, engages into a structured surface. The invention furthermore relates to an associated actuating unit and to an associated vehicle brake.

Brakes are commonly used in vehicles to decelerate these in a targeted manner. Such brakes have hitherto in most cases been hydraulically actuated, though electric actuation is also possible and will likely be used more commonly in future. Accordingly, there is also an increasing requirement to integrate parking brake functions into such electrically operated brakes. For this purpose, use may for example be made of a blocking slide which can engage into a structured surface and which can thus prevent a brake from disengaging after having been applied. It has however been found that the actuation of blocking slides does not always take place optimally.

It is therefore an object of the invention to provide an alternative or improved method, in relation to known embodiments, for actuating a blocking slide. It is furthermore an object of the invention to provide an actuating unit for a vehicle brake for carrying out such a method, and to provide a vehicle brake having such an actuating unit. This is achieved according to the invention by a method, an actuating unit and a vehicle brake according to the respective main claims. Advantageous refinements can be found, for example, in the respective dependent claims. The content of the claims is incorporated in the content of the description by express reference.

The invention relates to a method for actuating a blocking slide which is actuatable by means of an electromagnet and which, in at least one position, engages into a structured surface. The blocking slide thus prevents rotation of the structured surface in at least one direction of rotation. The method comprises the following steps:
moving the structured surface into a specified orientation, and then
applying a supply voltage to the electromagnet such that the blocking slide engages with the structured surface whilst the structured surface remains in the specified orientation.

By means of the method according to the invention, the structured surface can be actively moved into an orientation in which the blocking slide can engage particularly easily into the structured surface. Instances of improper actuation, which can arise for example as a result of the blocking slide setting down on a projection, can thus be avoided.

The blocking slide typically serves to prevent a rotation of the structured surface in at least one direction of rotation. For this purpose, the blocking slide engages into the structured surface and, in so doing, may for example engage into a recess of the surface. The blocking action may exist only in one direction of rotation, or may also exist in both directions of rotation.

The structured surface may in particular be formed on a shaft or on a ratchet wheel that is connected rotationally conjointly to a shaft. A rotation of the shaft can thus ultimately be blocked. The shaft may for example be used for actuating a brake. For this purpose, the shaft may for example be driven by means of an electric motor.

The specified orientation may for example be stored in a control device. It may be possible for said specified orientation to be adopted, or said specified orientation may be monitored, for example by means of an angle sensor or through the use of a stepper motor.

The supply voltage may in particular lead to the generation of a magnetic field that moves the blocking slide. In particular, the blocking slide may be movable in both directions by means of the electromagnet. Said blocking slide may in particular be supported so as to be movable one-dimensionally.

The orientation may in particular be a specified angular position or lie within a specified range of angular positions. In particular, a specified angular position may be a particular value. A specified range of angular positions may include angles within the range which in particular appear advantageous for reliable engagement of the blocking slide into the structured surface. For example, the orientation may be adopted so as to lie within the specified range.

The orientation of the structured surface or of the shaft may be monitored in particular by means of an angular position sensor. In one possible embodiment, the angular position sensor may define multiple segments within which it can distinguish angular positions. Here, in one embodiment, the angular position sensor cannot distinguish the segments from one another. This corresponds to typical embodiments of angular position sensors which can only measure within a specified range of angles but cannot measure what segment the actual angle is situated in. For example, five segments may be specified, which may each cover an angle range of 72°. The angle can then be determined only within a particular segment, that is to say is between 0° and 72° as an output variable. The angular position sensor however cannot identify which segment the actual angle is situated in.

In one advantageous embodiment, the structured surface has, along a circumference, a number of teeth and/or recesses that is equal to the number of segments multiplied by a natural number. The structured surface can thus be adapted to the functionality of the angular position sensor because, then, for the movement of the structured surface into the specified orientation, it is not of importance which segment the angle is situated in. A measurement within a particular segment is sufficient.

In one embodiment, for calibration, the shaft is rotated, whilst the blocking slide is in engagement, in the blocked direction as far as a stop. The angular position sensor can then be calibrated in particular on the basis of said stop. This allows easy and reliable calibration of the angular position sensor, which can in particular be implemented even if an angle of the structured surface relative to the angular position sensor is not specified as a consequence of production. The method for calibration may in particular also be repeated at regular intervals, for example every time a motor vehicle is started up, because components may in principle also be exchanged in the interim.

In particular, during the orientation, the blocking slide may engage into a recess of the structured surface. This makes it possible for said orientation to be knowingly adopted, such that the blocking slide engages as unproblematically as possible.

In one advantageous embodiment, the blocking slide, when engaged, prevents a rotation only in one direction of rotation. A rotation is thus possible in the other direction of rotation. This is unproblematic for example because it would cause an applied brake to be applied further.

The structured surface may in particular be moved into a release orientation before the blocking slide is released. The blocking slide may be moved out of engagement whilst the structured surface remains in the release orientation. The release can thus be made easier. The structured surface may be moved into the release orientation in particular by means of an electric motor which drives the structured surface or drives a shaft that is connected rotationally conjointly to the structured surface.

The invention furthermore relates to an actuating unit for a vehicle brake. The actuating unit has an electromagnet. Said actuating unit has a shaft with a structured surface. Said actuating unit has a blocking slide which is actuatable by means of the electromagnet and which, in at least one position, engages into the structured surface, wherein the blocking slide prevents a rotation of the structured surface in at least one direction of rotation. The actuating unit has a control device that is configured to carry out a method described herein. With regard to the method, reference can be made to all of the embodiments and variants described herein. In particular, features described with regard to the method may also be correspondingly applied to the actuating unit and vice versa.

The actuating unit may in particular furthermore have an electric motor for driving the shaft. This allows the shaft to be driven reliably.

The actuating unit may in particular have an angular position sensor for detecting an orientation of the shaft. Reference is made to the description already given above with regard to an angular position sensor.

The angular position sensor may in particular be a motor angle sensor of the electric motor. This allows a particularly compact and integrated design.

The structured surface may for example be formed directly on the shaft or may be formed on a ratchet wheel that is connected rotationally conjointly to the shaft.

The invention furthermore relates to a vehicle brake having at least one brake shoe and having at least one actuating unit as described herein. With regard to the actuating unit, reference can be made to all of the embodiments and variants described herein. The shaft may in particular be designed to actuate the brake shoe.

In other words, to lock a parking brake function, it is possible in particular for a desired setpoint clamping force to firstly be set. In the next step, a solenoid may be activated, and a pawl thus moved toward the ratchet wheel. Whilst the force on the pawl is maintained, the motor torque can be lowered, and an angle of rotation and a clamping force can be observed. If locking has been successful, the angular position and the clamping force are maintained.

A pawl may for example come into contact either with a gap in a ratchet wheel or with a tooth of the ratchet wheel or with a region situated in between. Not all of these forms of contact are optimal.

The likelihood of successful locking can be increased if the ratchet wheel is targetedly positioned such that the pawl or a blocking slide can be moved into the middle of a gap. The ratchet wheel may be rigidly connected to a motor shaft, and typically has a known number of teeth with an equidistant pitch. Furthermore, it is possible in particular for a motor position sensor to be used, the periodicity of which per mechanical revolution constitutes an integer divisor of the number of teeth. For example, a motor position sensor may mechanically output an angle of 0° to 360°, which corresponds to one period per revolution. The number of teeth can thus be arbitrary. If the motor position sensor mechanically outputs for example an angle from 0° to 72°, this corresponds to five periods per revolution, and it is therefore advantageous if the number of teeth is divisible by five.

It can thus be ensured in particular that a tooth or a gap of a ratchet wheel is situated in each case at the same locations across all sensor periods.

In order to adjust for an angular offset between the ratchet wheel and motor position sensor, a locking position may be adopted at least once by means of a calibration method, and the determined angular position may be stored in a nonvolatile memory.

From the construction, it can be determined in advance by what angle the ratchet wheel has to be rotated out of this position further in a brake-application direction in order that the pawl makes contact with the gap in the ratchet wheel with an evenly distributed clearance. If desired, the corrected value may also be stored.

To lock the clamping force, it is possible in particular for the following steps to be performed:
adjusting the target clamping force,
calculating the position of the next gap in the direction of brake application,
moving the drive to the gap position by closed-loop position control,
moving the pawl into the gap of the ratchet wheel,
reducing the torque,
checking whether stable positioning has been achieved.

For the release of the brake, it is likewise possible for the position of the gap to be calculated and for this to be adopted by closed-loop position control. The pawl can then subsequently be withdrawn (for example actively or by spring force).

The position in the locked state may be compared with the stored position in order to identify deviations, for example whether a tooth has broken away. It is likewise also possible, during operation, for the learned values to be further relearned, and thus for possible wear to be identified or compensated.

In particular, it is thus possible to achieve reliable locking without the risk of release owing to a small overlap. Fast locking can also be achieved, because the optimum position is adopted. Wear can be reduced. The generation of noise can also be reduced.

The embodiment described herein may be used for example for a parking lock, or for example also for a steering wheel lock or other applications.

Further features and advantages will be gathered by a person skilled in the art from the exemplary embodiment described below with reference to the appended drawing, in which:

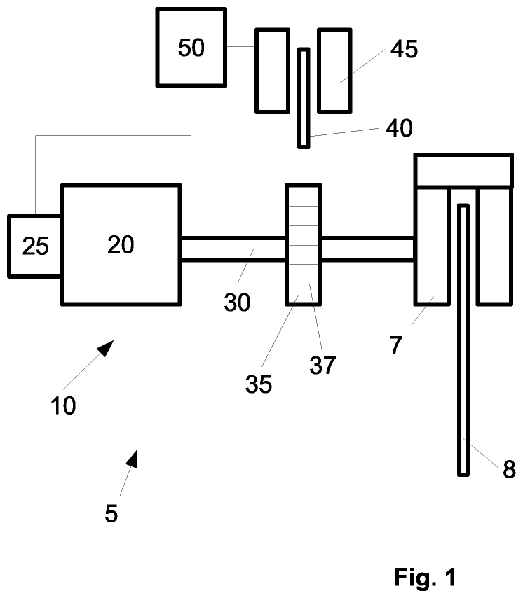

FIG. 1: shows a vehicle brake.

FIG. 1 is a purely a schematic illustration of a vehicle brake 5 according to an exemplary embodiment of the invention. The vehicle brake 5 has a brake disk 8 and a brake shoe 7 that can act on the brake disk 8. This is illustrated here purely schematically, and may be realized in various embodiments. To actuate the brake shoe 7, the vehicle brake 5 has an actuating unit 10 according to an exemplary embodiment of the invention.

The actuating unit 10 has an electric motor 20 having an integrated angular position sensor 25. The electric motor 20 is designed to drive a shaft 30 on which a ratchet wheel 35 is situated. The shaft 30 is designed to move the brake shoe 7 linearly. This may be implemented by way of a suitable conversion between rotation and translation (not illustrated).

A structured surface 37 is provided on the outside of the ratchet wheel 35. Said structured surface is in the form of teeth or projections. Situated adjacent to the structured surface 37 is a blocking slide 40 that can be actuated one-dimensionally by means of an electromagnet 45.

For the control of the vehicle brake 5, said vehicle brake has a control device 50. Said control device can both activate the electric motor 20 and supply electrical current to the electromagnet 45 and interrogate the angular position sensor 25.

If it is intended for the vehicle brake 5 to have a parking brake functionality, then the electric motor 20 is firstly actuated such that the brake shoe 7 performs a brake-application movement, and a rotation of the brake disk 8 is thus prevented. The electric motor 20 is then activated such that the structured surface 37 is moved into a specified angular position. Said specified angular position is selected such that the blocking slide 40 engages into a suitable intermediate space between two teeth. Whilst the structured surface 37 remains in this orientation, the electromagnet 45 is actuated such that the blocking slide 40 is deployed and engages into the structured surface 37. A rotation of the shaft 30 is then no longer possible, at least in one direction.

In order to improve the functionality for setting a suitable orientation, the structured surface 37 has a number of teeth which corresponds to an integer multiple of a number of sectors of the angular position sensor 25. For example, use may be made of an electric motor 20 having five poles, wherein, in such cases, use is typically made of an angular position sensor 25 that is divided into five segments, that is to say outputs only output values in the range from 0° to 72° and cannot distinguish the segments from one another. In this case, the number of teeth of the structured surface 37 is preferably an integer multiple of the number 5, such that the limitation in the measurement of the angle no longer plays a role.

For the purposes of calibration, the blocking slide 40 can be engaged and the electric motor 20 can be actuated such that the shaft 30 rotates in a direction that is to be blocked, until said shaft can be rotated no further. The corresponding angle can be measured by means of the angular position sensor 25 and can be stored. In this way, both immediately after a production process that yields an undefined angular relationship, and also for example upon a start-up of a motor vehicle, on which components may in principle have been exchanged during a standstill period, a reliable defined angular relationship can be established between the structured surface 37 and the measurement functionality of the angular position sensor 25.

Steps of the method according to the invention that have been mentioned may be carried out in the order stated. They may however also be carried out in a different order if this is technically appropriate. In one of its embodiments, for example with a specific combination of steps, the method according to the invention may be carried out in such a way that no further steps are carried out. In principle, however, further steps, even steps which have not been mentioned, may also be carried out.

Note that features may be described in combination in the claims and in the description, for example in order to facilitate understanding, even though said features may also be used separately from one another. A person skilled in the art will recognize that such features may also, independently of one another, be combined with other features or combinations of features.

Dependency references in dependent claims may characterize preferred combinations of the respective features but do not exclude other combinations of features.

### LIST OF REFERENCE DESIGNATIONS

5 Vehicle brake
7 Brake shoe
8 Brake disk
10 Actuating unit
20 Electric motor
25 Angular position sensor
30 Shaft
35 Ratchet wheel
37 Structured surface
40 Blocking slide
45 Electromagnet
50 Control device

1. A method for actuating a blocking slide (40) which is actuatable by means of an electromagnet (45) and which, in at least one position, engages into a structured surface, whereby the blocking slide (40) prevents a rotation of the structured surface (37) in at least one direction of rotation,
wherein the method comprises the following steps:
moving the structured surface (37) into a specified orientation, and then
applying a supply voltage to the electromagnet (45) such that the blocking slide (40) engages with the structured surface (37) whilst the structured surface (37) remains in the specified orientation.

2. The method as claimed in claim 1,
wherein the structured surface (37) is formed on a shaft (30) or on a ratchet wheel (35) that is connected rotationally conjointly to the shaft (30).

3. The method as claimed in any one of the preceding claims,
wherein the orientation is a specified angular position or lies within a specified range of angular positions.

4. The method as claimed in any one of the preceding claims,
wherein the orientation of the structured surface (37) or of the shaft (30) is monitored by means of an angular position sensor (25).

5. The method as claimed in claim 4,
wherein the angular position sensor (25) defines multiple segments within which it can distinguish angular positions, wherein the angular position sensor (25) cannot distinguish the segments from one another.

6. The method as claimed in claim 5,
wherein the structured surface (37) has, along a circumference, a number of teeth and/or recesses that is equal to the number of segments multiplied by a natural number.

7. The method as claimed in claim 2 or any claim dependent thereon,
wherein, for calibration, the shaft (30) is rotated, whilst the blocking slide (40) is in engagement, in the blocked direction as far as a stop, and
the angular position sensor (25) is calibrated on the basis of said stop.

8. The method as claimed in any one of the preceding claims,
wherein, during the orientation, the blocking slide (40) engages into a recess of the structured surface (37).

9. The method as claimed in any one of the preceding claims,
wherein the blocking slide (40), when engaged, prevents a rotation only in one direction of rotation.

10. The method as claimed in any one of the preceding claims,
wherein the structured surface (37), before a release of the blocking slide (40), is moved into a release orientation, and
the blocking slide (40) is moved out of engagement whilst the structured surface (37) remains in the release orientation.

11. An actuating unit (10) for a vehicle brake, comprising
an electromagnet (45),
a shaft (30) having a structured surface (37),
a blocking slide (40) which is actuatable by means of the electromagnet (45) and which, in at least one position, engages into the structured surface (37), wherein the blocking slide (40) prevents a rotation of the structured surface (37) in at least one direction of rotation, and
a control device (50) that is configured to execute a method as claimed in any one of the preceding claims.

12. The actuating unit (10) as claimed in claim 11,
which furthermore comprises an electric motor (20) for driving the shaft (30).

13. The actuating unit (10) as claimed in either one of claims 11 and 12,
which comprises an angular position sensor (25) for detecting an orientation of the shaft (30).

14. The actuating unit (10) as claimed in claim 12 and claim 13,
wherein the angular position sensor (25) is a motor angle sensor of the electric motor (20).

15. A vehicle brake (5), comprising
at least one brake shoe (7), and
at least one actuating unit (10) as claimed in any one of claims 11 to 14,
wherein the shaft (30) is designed to actuate the brake shoe (7).
